(19) United States
(12) Patent Application Publication
(10) Pub. No.: US 2013/0332386 A1
(43) Pub. Date: Dec. 12, 2013

(54) CONTENT MANAGEMENT

(71) Applicants: David Paul Billmaier, Woodinville, WA (US); Jason Christopher Hall, Seattle, WA (US); Alexander Charles Barclay, Seattle, WA (US); John Max Kellum, Seattle, WA (US); Henry Hideyuki Yamamoto, Issaquah, WA (US)

(72) Inventors: David Paul Billmaier, Woodinville, WA (US); Jason Christopher Hall, Seattle, WA (US); Alexander Charles Barclay, Seattle, WA (US); John Max Kellum, Seattle, WA (US); Henry Hideyuki Yamamoto, Issaquah, WA (US)

(21) Appl. No.: 13/494,465

(22) Filed: Jun. 12, 2012

(51) Int. Cl. G06Q 30/00

(52) U.S. Cl. 705/347

(57) ABSTRACT

A system and method for managing content are provided herein. The method includes accepting a content entry related to a product. The method also includes receiving a content rating for the content entry from a user. Additionally, the method includes calculating a combined rating for the content entry based at least in part on the content rating. Furthermore, the method includes determining a persistent status of the content entry based on the combined rating.

### BACKGROUND

The introduction of social networking has transformed the manner in which people communicate, share experiences, and exchange information via the Internet. This transformation has resulted in an increasing number of businesses encouraging users to provide content related to the businesses' product line. The content provided by users allows businesses to monitor the general public's interest in certain products, which in turn assists the businesses in developing products. For example, a website may contain a product listing with a user comments section, which allows online users to post reviews or any other pertinent information related to the listed products. The user comments section can be monitored by the product's manufacturer in order to obtain user reviews of their products. The ability to access user reviews allows for businesses to collect unsolicited information regarding certain products, which can help the businesses shape their advertising and marketing initiatives.

Additionally, creating an online forum that includes user provided content can be a helpful resource for other users and customers. For example, user provided content associated with a particular music artist can help users identify emerging music artists with a similar style. The user provided content can also help to boost the popularity of a product, thereby providing a new source of marketing for the manufacturer or creator of the product. Ultimately, user provided content can include relevant and useful information that benefits users and businesses alike.

### BRIEF DESCRIPTION OF THE DRAWINGS

The following detailed description may be better understood by referencing the accompanying drawings, which contain specific examples of numerous objects and features.

FIG. 1 is a block diagram of an example of a computing system that may be used for the management of content.

FIG. 2 is a process flow diagram illustrating an example of a method for management of content.

FIG. 3 is a block diagram illustrating an example of data flow in a method of content management.

FIG. 4A is a process flow diagram depicting an example of a method for management of content.

FIG. 4B is a continuation of FIG. 4A depicting an example of a method for management of content.

FIG. 5 is a block diagram depicting an example of a tangible, non-transitory, computer-readable medium that stores a protocol adapted to manage content.

### DETAILED DESCRIPTION OF SPECIFIC EXAMPLES

Online forums that include user provided content continue to grow in popularity. Through user provided content, such as a user comment or a website link provided by a user, users can share their experiences with certain products and also provide information that is helpful or interesting to other users. However, online forums can quickly become inundated with user provided content, which makes locating the most interesting and relevant user provided content challenging. Unfortunately, current systems provide only basic means for gathering user provided content, and do not provide a means for effectively identifying user provided content that may be more relevant than other user provided content. Therefore, a management system that manages the user provided content would allow for users to quickly locate the most relevant and interesting information found within the user provided content.

User provided content can contain a wide array of information. A content entry, as used herein, can include a user comment, a link to a blog, a website link provided by the user, audio or video media provided by the user, or any similar content a user may share either online or through an application that accepts content. Additionally, the content entries can relate to a broad range of products. A product, as used herein, can refer to a tangible or intangible product, such as a printer, a laptop, an audio digital recording, or a video digital recording. The term product can also refer to a product line or a set of products, such as a series of laptops, or a playlist of audio or video digital recordings. For example, a content entry for a product can include a user comment related to a particular laptop for sale on a website. A content entry for a product can also include, for example, a website link related to a music artist. An additional example of a content entry for a product is a user comment that relates to a section of an audio playlist.

The content entries can be provided by any user of the online forum. A user, as used herein, includes any individual using a computing system to provide a content entry. Content entries may also be provided automatically by a computing system. For example, a computing system operated by a recording studio can automatically provide content entries for a particular music artist based on social media status updates by the music artist. Additionally, a user may or may not be affiliated with the product related to the content entry. For example, a user can be an individual that posts a content entry related to a particular printer, even though the individual may be a member of the marketing team for the manufacturer of the printer.

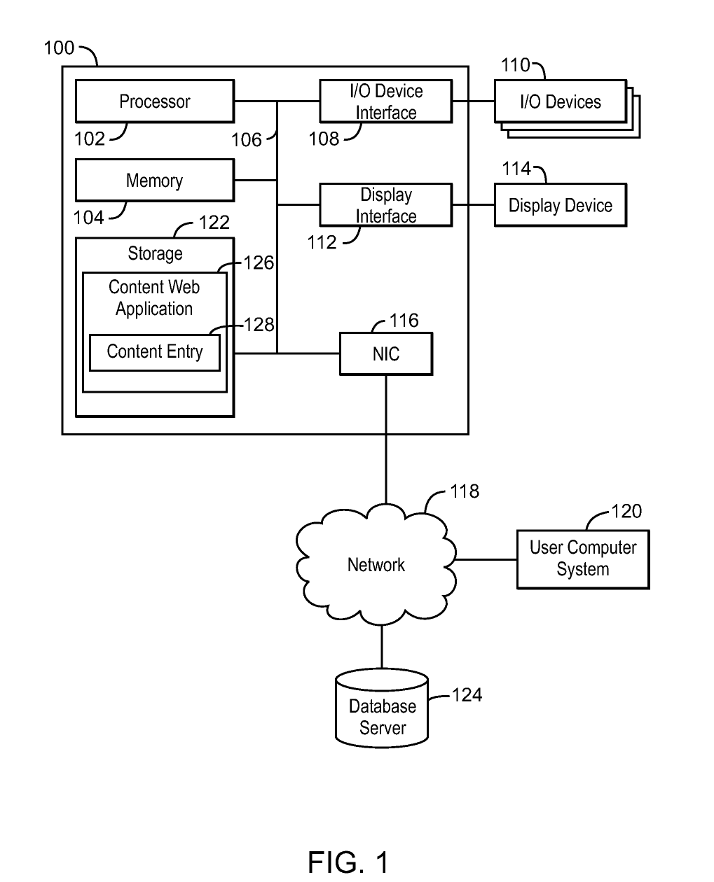

FIG. 1 is a block diagram of a computing system 100 that may be used for the management of content. The computing system 100 may be, for example, a mobile phone, laptop computer, desktop computer, or tablet computer, among others. The computing system 100 may include a processor 102 that is adapted to execute stored instructions, as well as a memory device 104 that stores instructions that are executable by the processor 102. The processor 102 can be a single core processor, a multi-core processor, a computing cluster, or any number of other configurations. The memory device 104 can include random access memory (e.g., SRAM, DRAM, SONOS, eDRAM, EDO RAM, DDR RAM, RRAM, PRAM, among others), read only memory (e.g., Mask ROM, PROM, EPROM, EEPROM, among others), flash memory, or any other suitable memory systems. The instructions that are executed by the processor 102 may be used to implement a method that includes managing content.

The processor 102 may be connected through a system bus 106 (e.g., PCI, PCI Express, HyperTransport®, Serial ATA, among others) to an input/output (I/O) device interface 108 adapted to connect the computing system 100 to one or more I/O devices 110. The I/O devices 110 may include, for example, a keyboard and a pointing device, wherein the pointing device may include a touchpad or a touchscreen, among others. The I/O devices 110 may be built-in components of the computing system 100, or may be devices that are externally connected to the computing system 100.

The processor 102 may also be linked through the system bus 106 to a display interface 112 adapted to connect the computing system 100 to a display device 114. The display device 114 may include a display screen that is a built-in component of the computing system 100. The display device 114 may also include a computer monitor, television, or projector, among others, that is externally connected to the computing system 100.

A network interface card (NIC) 116 may be adapted to connect the computing system 100 through the system bus 106 to a network 118. The network 118 may be a wide area network (WAN), local area network (LAN), or the Internet, among others. Through the network 118, the computing system 100 may accept content entries 128 from the content web application 126. The computing system 100 may also store the content entries 128 within a storage device 122 of the computing system 100.

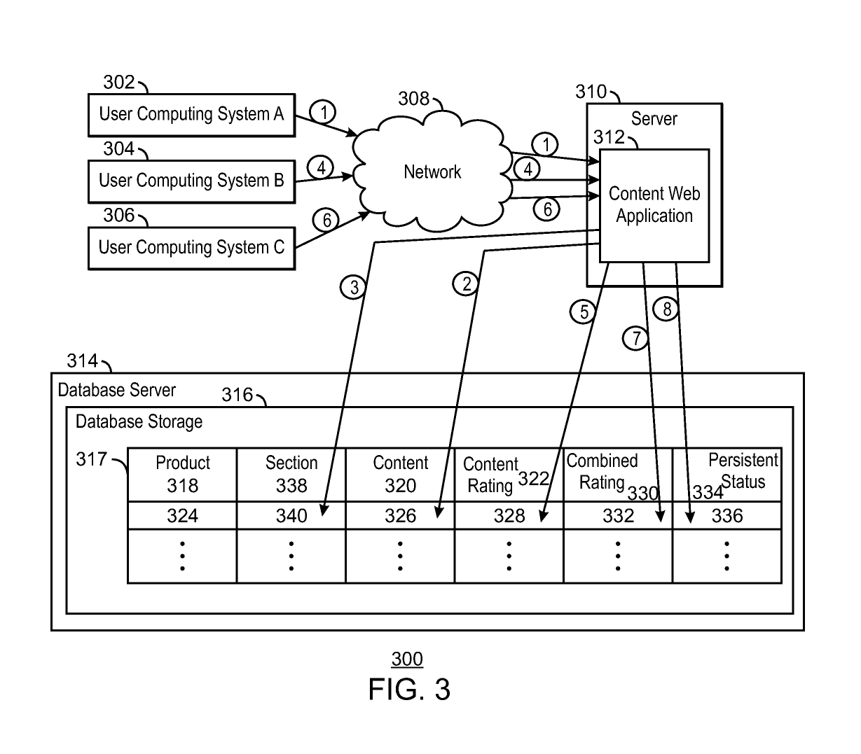

Through the network 118, the computing system 100 may be communicably coupled to a database server 124 and a user computer system 120. The database server 124 may include any type of computing device that is adapted to store content data, which is discussed in greater detail below in relation to FIG. 3. Such content data may include, for example, product information, content entries, content ratings, combined ratings, and a persistent status. The computing system 100 can receive content entries 128 from the user computer system 120 through the content web application 126 that resides in storage 122.

The storage device 122 can include a hard drive, an optical drive, a thumbdrive, an array of drives, or any combinations thereof. The storage device 122 may include a content web application 126 that is adapted to perform the management of content as described herein. The content web application 126 may obtain content data from the database server 124 and the user computer system 120.

It is to be understood that the block diagram of FIG. 1 is not intended to indicate that the computing system 100 is to include all of the components shown in FIG. 1. Rather, the computing system 100 can include fewer or additional components not illustrated in FIG. 1 (e.g., video cards, audio cards, additional network interfaces, etc.). Furthermore, any of the functionalities of the content web application 126 may be partially, or entirely, implemented in hardware and/or in the processor 102. For example, the functionality may be implemented with an application specific integrated circuit, in logic implemented in the processor 102, in a co-processor on a peripheral device, etc.

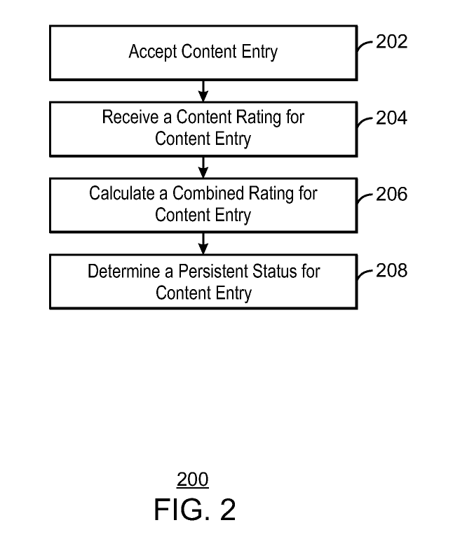

FIG. 2 is a process flow diagram illustrating an example of a method for management of content. The method 200 may be used to manage content by using a computing system, such as the computing system 100 described in FIG. 1. The method 200 may be implemented in response to content entries 128 received from the user computing system 120, as discussed above in FIG. 1. The content entries are stored in the database server 124, so that the content web application 126 can display the content entries 128 proximate the product related to the content entries 128. For example, content entries 128 can be displayed for other users to view through the content web application 126. The content entries 128 can be associated with the product to which they relate in any number of configurations. For example, a queue containing the content entries 128 may be displayed below a product. In other examples, the content entries 128 may be accessible via a link that is close in proximity to the product as displayed through the content web application 126.

The method begins at block 202 by accepting a content entry related to a product. As discussed above, the content entry can include a user comment, a link to a blog, a website link provided by the user, audio or video media provided by the user, or any similar content a user may share either online or through an application that accepts content. Examples of content entries related to products include a user comment pertaining to a brand of printer or a user comment pertaining to a group of songs included in an audio playlist. The accepted content entry then becomes associated with a particular product. For example, a user comment related to a particular audio digital recording may be visible proximate the audio digital recording. Once the content entry is accepted, other users viewing the product can also view the user generated comment entry.

At block 204, a content rating for the content entry is received. The content ratings are based on any combination of factors regarding the relationship between the content entry and the associated product. For example, a user comment that is associated with a computer printer, but actually discusses a computer monitor, might be irrelevant and receive low content ratings from other users. In contrast, a user comment that includes a website link to a rare performance by a music artist might be considered interesting and receive high content ratings from other users. Any rating system can be used to rate the content entry. For example, a binary “up or down” rating system can be used in which users select if the content entry is relevant or irrelevant with regard to the related product. Another example of a rating system is a star rating system, in which users can determine a level of helpfulness or relevancy of the content entry by selecting a number of stars. For instance, the rating system can include five stars. In a five star rating system, a very helpful or relevant content entry receives five stars, while a very unhelpful or irrelevant content entry receives only one star.

At block 206, a combined rating for the content entry is calculated. For example, the content ratings for the content entry can be combined, so that a single combined rating represents the average of all the content ratings from other users. In another example, the combined rating for the content entry might be calculated using a weighted average in which the most recent content ratings have a more significant influence on the combined rating. The combined rating may also be affected by the number of users that have provided a content rating. For example, if a small number of users have provided a content rating for a content entry, the combined rating may be based on other criteria. For instance, the combined rating may be based on the number of times users clicked on a website link provided within the content entry.

At block 208, a persistent status of the content entry is determined. The persistent status, as referred to herein, describes a situation in which a content entry becomes persistently associated with a related product by satisfying a set of criteria. For example, once a combined rating for a content entry is above a certain threshold and a certain number of users have provided content ratings, then the content entry receives a persistent status. In some examples, content entries that have a persistent status appear closer in proximity to the related product than content entries without a persistent status. As another example, a content entry that has a persistent status may “drift” to the top of a list that is arranged in time and date order, such as from oldest to youngest, as earlier content entries are removed.

A content entry that has acquired a persistent status can subsequently lose the persistent status if the combined rating for the content entry decreases. For example, a user comment may include information pertaining to a poor musical performance by a particular music artist. Initially, the user comment might receive high content ratings and receive a persistent status. However, the user comment might not continue to attract interest from other users after a certain period of time has elapsed. Therefore, the user comment might subsequently receive low content ratings, thereby reducing the combined rating of the user comment and causing the user comment to lose its persistent status.

In some examples, content entries that do not acquire a persistent status within a certain period of time are deleted. Additionally, a configurable content velocity constant may be used to determine the persistent status of a content entry based on an increasing number of user comments regarding the content entry in relation to time. For example, a user comment related to a computer laptop might receive the highest content rating by a small number of users soon after the user comment is accepted. Additionally, the number of high content ratings might increase in relation to time, so that the user comment is receiving an exponentially larger number of content ratings as time passes. Before waiting for a certain number of users to provide a content rating before determining a persistent status for the user comment, a configurable content velocity constant might be used to indicate that the user comment is very helpful and relevant. In this example, the user comment would attain a persistent status once the number of content ratings within a period of time surpasses the configurable content velocity constant, such as a number of user comments per minute.

FIG. 3 is a block diagram illustrating an example of data flow in a method of content management. The data flow begins with user computing system A 302 sending (indicated by the circled 1) a content entry to the content web application 312 through the network 308. The content web application 312 may reside in the server 310. The content web application 312 then sends the content entry to the database server 314, as indicated by the circled 2. The database server 314 includes database storage 316, which stores data related to products and content entries in a database table 317. The database table 317 can include several columns that store data related to products and content entries. For example, the product column 318 stores data that identifies a particular product. In this example, a product identifier that is related to a particular laptop may be stored at block 324. In other examples, the product identifier may be related to a group of products, such as a playlist that includes a number of songs from different music artists. The database table 317 also includes a content column 320 that stores the content entries in relation to the associated products. For example, a content entry stored at 326 is related to the product identifier located at block 324. The content entry can include any content, such as a user comment related to an audio digital recording.

The content web application 312 then determines a section identifier for the content entry. The section identifier allows the content web application 312 to organize the content entries into different sections. This allows the content web application 312 to display content entries together based on certain characteristics. For example, content entries that only include a website link might be displayed in a different section than content entries that include user comments. Once the section identifier has been determined for the content entry, the section identifier is stored (as indicated by the circled 3) in the database table 317 in the section column 338.

After the content entry has been stored at 326, the content web application 312 allows users to provide content ratings. As an example, user computing system B 304 sends (as indicated by the circled 4) a content rating to the content web application 312 regarding the content entry previously sent by user computing system A 302. The content rating can be generated based on a variety of rating systems, as described above in relation to block 204 of FIG. 2. The web application 312 then stores (as indicated by the circled 5) the content rating in the content rating column 322 of the database table 317. For example, the content rating received by the content web application 312 from user computing system B 304 regarding the content entry stored at 326 is stored (as indicated by the circled 4) at block 328. The content web application 312 can then receive additional content ratings for the content entry stored at block 326 from other users (as indicated by the circled 6), such as user computing system C 306. The content web application 312 can then store the content ratings for the content entry at block 326 in a data structure at block 328. The data structures that can store the content ratings include vectors, arrays, linked lists, etc. In some examples, the content ratings stored within the content rating column may be updated with each newly received content rating, by calculating a weighted average between the newly received content rating and the stored content rating.

A separate combined rating column 330 may be included in the database table 317 to store the combined rating for each content entry stored in column 320. As discussed above in relation to block 206 of FIG. 2, the combined rating may be affected by the number of users that have provided a content rating. If a small number of users have provided content ratings for a content entry, the combined rating may be based on other criteria, such as the number of times users clicked on a website link provided within the content entry. Once the web application receives content ratings, the combined rating (as indicated by the circled 7) is calculated and stored at block 332. For example, the combined rating for a content entry may be calculated each time the content web application 312 receives a new content rating. In some examples, the combined rating is determined by calculating the average of the content ratings in the data structure stored in the content rating column, such as block 328.

Once the content web application 312 has a combined rating, a persistent status can be determined for the content entry. After determining if a content entry meets the criteria for a persistent status, the content web application 312 stores (as indicated by the circled 8) the result of the persistent status determination in column 334. As discussed above in relation to block 208 of FIG. 2, a content entry that maintains a persistent status is persistently associated with a particular product. The content entries that attain a persistent status are not deleted from the database table 317 after a time interval has elapsed.

The block diagram of FIG. 3 is for illustrative purposes only and can store data in any number of different configurations. For example, additional columns can be added to the database table 317 to store additional data related to a product or content entry. Also, the columns of database table 317 can be rearranged in a number of different configurations. Furthermore, the content web application 312 may include any number of additional components not shown in FIG. 3, depending on the specific application.

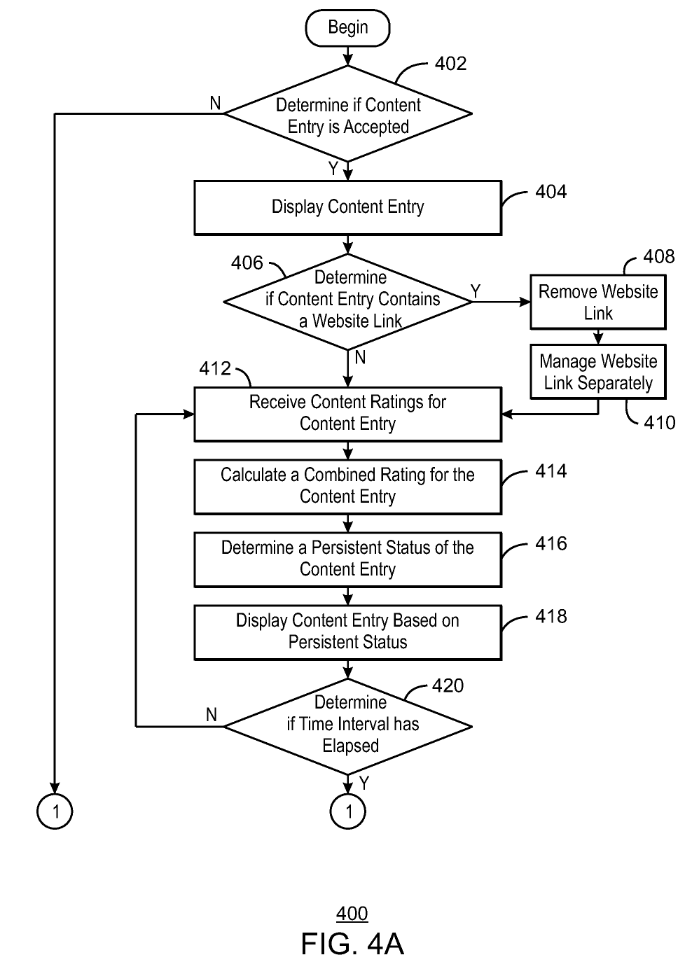

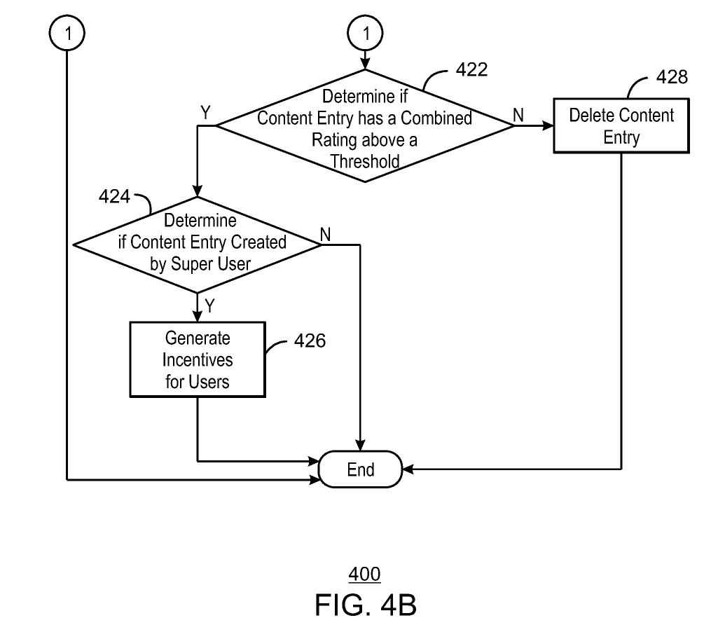

FIG. 4 is a process flow diagram depicting an example of a method for management of content. The method 400 may be used to manage content and may be implemented using a computing system, such as the computing system 100 described in FIG. 1. The method 400 may be implemented in response to content entries 128 received from the user computing system 120, as discussed above in FIG. 1. The method 400 may also be implemented in response to content entries received by the server 310, as discussed above in FIG. 3.

At block 402 it is determined if a content entry related to a product is accepted. Many web applications only allow users to submit content entries provided that the users follow certain terms of use agreements. For example, many web applications prohibit users from submitting content entries that include vulgarity, violations of copyright laws, and the like. If the content entry is determined to violate a terms of use agreement for the web application, the content entry is not accepted. Accordingly, the content entry is not stored in the database server 314 and the content entry is not viewable by other users. If the content entry complies with the terms of use agreement, the process continues at block 404. Determining if the content entry complies with the terms of use agreement may be performed manually or by an automated screening function within the web application.

At block 404, the content entry is displayed so users can view the content entry. Each content entry is displayed based on the persistent status of the content entry, which is discussed in more detail below in relation to block 418. However, a new content entry may not have a persistent status because users have not yet provided content ratings for the content entry. Therefore, a new content entry may initially be displayed, for example, at the top of the content entries that do not have a persistent status. In other examples, a new content entry may initially be displayed in a separate section that includes new content entries that do not have content ratings.

At block 406, it is determined if a content entry includes a website link. For example, the content entry may be a user comment that includes a website link and a discussion of the content viewable via the website link. If the content entry includes a website link, the process continues at block 408. If the content entry does not include a website link, the process continues at block 412.

At block 408, the website link may be removed from the content entry. For example, a user comment that relates to a particular music artist can include a website link to a recording of a performance by the music artist. The user comment may also include a discussion regarding the user's impression of the performance. The website link may be removed from the user comment. In another example, the website link may be left in the user comments, which can then be displayed and rated, as described starting at block 412.

At block 410, a website link that was removed at block 408 may be placed in a separate content entry with a website section identifier. Removal of the website link from the content entry allows users to view and rate the website link separately from the other content within the content entry. Thus, the website links can attain a persistent status or can be deleted from the database server after a period of time. For example, a website link within a user comment may remain popular with users for an extended period of time. However, the user's dialog within the user's comment may lose popularity with users over time. In this example, the website link may attain a persistent status and remain associated with the product, while the user's dialog does not attain a persistent status and is deleted from the database server after a period of time.

At block 412, content ratings for content entries are received. The content ratings are received in the same manner as discussed above at block 204 of FIG. 2. Any content rating system, such as an “up or down” rating system or star rating system, can be used to rate the content entry. Users have the ability to select a content rating based on the rating system and the content rating is submitted to the database server 314, as described above in FIG. 3.

At block 414, a combined rating is calculated for the content entry. The combined rating is calculated in the same manner as discussed above at block 206 of FIG. 2. For example, the content ratings for the content entry can be combined, so that a single combined rating represents the average of all the received content ratings.

At block 416, a persistent status of the content entry is determined. The persistent status of the content entry is determined in the same manner as discussed above at block 208 of FIG. 2. In some examples, content entries that do not acquire a persistent status within a certain period of time are deleted. Also, in some examples, a content entry that has acquired a persistent status can subsequently lose the persistent status if the combined rating for the content entry decreases.

At block 418, the content entry is displayed based on its persistent status. Content entries that have a persistent status are displayed proximate the related product such that other users can easily view the persistent content entries. For example, if the content entries are viewed in a list that is located below the product in the web application, then the content entries with a persistent status can be at the top of the list. The content entries can be displayed in relation to a product in various different configurations. For example, the content entries with a persistent status might be displayed above a product, while the content entries without a persistent status are displayed below a product. In other examples, the content entries may be listed based on the time of creation of the content entries. After a time interval, content entries that have not acquired a persistent status are deleted, which results in content entries with a persistent status becoming more visible and propagating higher on the content list. In another example, the content entries are displayed based on their combined ratings. In this example, a list of content entries is organized so that the highest rated content entries appear first on the list, while the lowest rated content entries appear at the bottom of the list.

At block 420, it is determined if a time interval has elapsed. The time interval determines when certain content entries are deleted, as discussed below at block 428. In some examples, the time interval is a static amount of time. In other examples, the time interval is a dynamic period of time that can fluctuate depending on any number of factors. For example, products that do not receive a large number of content entries may have a longer time interval, which prevents the small number of content entries from potentially being deleted. However, the product may subsequently attract the attention of a larger number of users after a published article or news story that relates to the product. As a result of the increased user attention, a larger number of users may submit content entries for the product. In order to maintain a certain maximum number of content entries, the time interval may be shortened. The shortened time interval reduces the number of content entries that have not reached a persistent status. As another example, a product with a shorter active life cycle may have a shorter time interval before comments are deleted, while products with a longer active life cycle may have a longer time interval before comments are deleted. In this example, a pop song may have an interval of a week, while a car may have an interval of a month.

If the time interval has not elapsed, the process returns to block 412 to receive additional content ratings for the content entry. By returning to block 412, the content entry can subsequently attain a persistent status if it has not done so already. If the time interval has elapsed, the process continues at block 422.

At block 422, it is determined if the content entry has a combined rating above a threshold, as discussed with respect to FIG. 2. The threshold represents a minimum combined rating that corresponds with a content entry that is considered helpful, interesting, or relevant. For example, a threshold of three in a five star rating system identifies all content entries with a combined rating between three and five stars as helpful, interesting, or relevant. If the content entry has a combined rating below a threshold, the process continues at block 428. If the content entry has a combined rating above a threshold, the process continues at 424.

At block 424, a determination is made as to whether the content entry that has a combined rating above a threshold was provided by a user that has provided other content entries with a combined rating above the threshold. After a user has provided a certain number of content entries above a threshold, the user can become a super user. A super user, as defined herein, is a user eligible to receive any number of incentives as further discussed below in relation to block 426. If the user that provided the content entry has not yet become a super user, the process ends. If the user that provided the content entry has become a super user, the process continues at block 426.

At block 426, incentives are generated for the super user. Incentives can include identifying the user as an expert user, providing the user with moderating rights, providing the user with editing rights, and the like. For example, a user with incentives may be allowed to remove content entries that are unrelated to the product with which they are currently associated. In this example, a user with incentives may be allowed to remove a user comment associated with a particular music artist because the user comment actually relates to a different music artist. The incentives encourage users to provide high quality content entries which results in content entries that are more relevant, interesting, and helpful to other users. After incentives are generated for the super user, the process ends.

At block 428, a content entry is deleted after it has been determined that the content entry does not have a combined rating above a threshold. For example, a content entry that has a two star rating within a five star rating system is not considered relevant, interesting, or helpful. Therefore, the content entry is deleted from the database server. Once the content entry has been deleted, other users do not have the ability to view the content entry any longer. After the content entry is deleted, the process ends.

The process flow diagram of FIG. 4 is not intended to indicate that the steps of the method 400 are to be executed in any particular order, or that all of the steps of the method 400 are to be included in every case. Further, any number of additional steps may be included within the method 400, depending on the specific application. For example, the method 400 may include removing items other than website links, such as user created videos, from content entries and managing the removed items as separate user generated items entries.

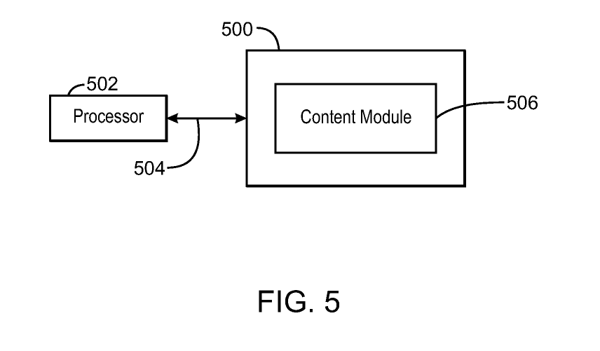

FIG. 5 is a block diagram showing a tangible, non-transitory, computer-readable medium 500 that manages content entries. The tangible, non-transitory, computer-readable medium 500 may be accessed by a processor 502 over a computer bus 504. Furthermore, the tangible, non-transitory, computer-readable medium 500 may include code to direct the processor 502 to perform the steps of the current method.

The various software components discussed herein may be stored on the tangible, non-transitory, computer-readable medium 500, as indicated in FIG. 5. For example, a content management module 506 may be adapted to direct the processor 502 to manage the content entries related to a product. It is to be understood that any number of additional software components not shown in FIG. 5 may be included within the tangible, non-transitory, computer-readable medium 500, depending on the specific application.

The present examples may be susceptible to various modifications and alternative forms and have been shown only for illustrative purposes. Furthermore, it is to be understood that the present techniques are not intended to be limited to the particular examples disclosed herein. Indeed, the present techniques include all alternatives, modifications, and equivalents falling within the true spirit and scope of the appended claims.

1. A method comprising:
accepting a content entry related to a product;
receiving a content rating for the content entry from a user;
calculating, via a processor, a combined rating for the content entry based, at least in part, on the content rating; and
determining, via the processor, a persistent status of the content entry based on the combined rating.

2. The method of claim 1 further comprising deleting the content entry after a time interval has elapsed or the content entry does not have a combined rating above a threshold.

3. The method of claim 1, further comprising displaying a content entry with a persistent status prior to a content entry without a persistent status.

4. The method of claim 1, wherein determining a persistent status of the content entry based on the combined rating further comprises calculating a configurable content velocity constant for the content entry.

5. The method of claim 1, wherein calculating a combined rating for the content entry based on the content rating further comprises determining a number of times a website link is selected within the content entry.

6. The method of claim 1, further comprising:
removing a website link from the content entry; and
managing the website link as a separate content entry.

7. The method of claim 1, wherein the product comprises a printer, a computing system, audio content, a playlist of audio content, video content, or a playlist of video content.

8. The method of claim 7, wherein the content entry comprises a user comment, a link to a blog, a website link provided by the user, audio content, or video content provided by the user.

9. The method of claim 1, further comprising:
determining a section identifier for the content entry; and
displaying the content entry in a section based on the section identifier.

10. The method of claim 1 further comprising:
identifying a user that has created a number of content entries that have attained a persistent status; and
generating a plurality of incentives for the user.

11. A system comprising:
a network interface card to communicate content data with a server through a network;
an input device to receive a content entry;
a display device to display the content entry;
a storage device to store a content web application, wherein the content web application is to manage the content entry; and
a processor to:
accept the content entry related to a product;
receive the content rating for the content entry from a user;
calculate a combined rating for the content entry based, at least in part, on the content rating;
determine a persistent status of the content entry based on the combined rating; and
display a content entry with a persistent status prior to a content entry without a persistent status.

12. The system of claim 11, wherein the processor is to delete the content entry after both a time interval has elapsed and the combined rating of the content entry is not above a threshold.

13. The system of claim 11, wherein the processor is to calculate a configurable content velocity constant for the content entry.

14. The system of claim 11, wherein the processor is to determine a number of times a link is selected within the content entry.

15. A tangible, non-transitory, computer-readable medium comprising instructions to direct a processor to:
accept a content entry related to a product;
receive a content rating for the content entry from a user;
calculate a combined rating for the content entry based, at least in part, on the content rating;
determine a persistent status of the content entry based on the combined rating; and
delete the content entry after both a time interval has elapsed and the combined rating of the content entry is not above a threshold.

16. The tangible, non-transitory, computer-readable medium of claim 15, wherein the instructions are to direct the processor to display a content entry with a persistent status prior to a content entry without a persistent status.

17. The tangible, non-transitory, computer-readable medium of claim 15, wherein the instructions are to direct the processor to calculate a configurable content velocity constant for the content entry.

18. The tangible, non-transitory, computer-readable medium of claim 15, wherein the instructions are to direct the processor to determine a number of times a link is selected within the content entry.

19. The tangible, non-transitory, computer-readable medium of claim 15, wherein the instructions are to direct the processor to:
remove a website link from the content entry; and
manage the website link as a separate content entry.

20. The tangible, non-transitory, computer-readable medium of claim 15, wherein the instructions are to direct the processor to:
determine a section identifier for the content entry; and
display the content entry in a section based on the section identifier.
